(19) United States
(12) Patent Application Publication
(10) Pub. No.: US 2023/0222511 A1
(43) Pub. Date: Jul. 13, 2023

(54) METHODS AND SYSTEMS FOR PROACTIVE CUSTOMER SUPPORT USING GENERAL PURPOSE LANGUAGE MODELS WITH TRANSFER LEARNING

(71) Applicant: VMware, Inc., Palo Alto, CA (US)

(72) Inventors: Ashot BAGHDASARYAN, Gyumri (AM); Tigran BUNARJYAN, Yerevan (AM); Arnak POGHOSYAN, Yerevan (AM); Ashot Nshan HARUTYUNYAN, Yerevan (AM); Jad EL-ZEIN, Herndon, VA (US)

(73) Assignee: VMware, Inc., Palo Alto, CA (US)

(21) Appl. No.: 17/572,960

(22) Filed: Jan. 11, 2022

(51) Int. Cl. G06Q 30/00; G06N 5/04; G06N 5/02

(52) U.S. Cl. CPC G06Q 30/016; G06N 5/04; G06N 5/025

(57) ABSTRACT

An AI-driven support system is described herein. This system includes a request formed from least one of a support request and a knowledge base. The system also includes an extractor module made up of a data pipeline configured to construct a training dataset from an input of at least one of said support request and said knowledge base, a training pipeline configured to take said training dataset use a BERT language model to generate at least one feature vector, and an evaluation pipeline fit to compare outputs from at least one iteration of said training pipeline, as well as output at least one parsed feature vector. The AI-driven support system further includes a recommendation module configured to request one of said support request and a corresponding feature vector from said parsed feature vector and comparing said corresponding feature vector to at least one remaining feature vector to find similar feature vectors, said recommendation module further configured to store said parsed feature vectors to compare with future iterations that generate at least one new parsed feature vector. Finally, there is at least one recommendation which is generated based on said similar feature vectors, and trends in said recommendations are tracked and used to create at least one rule.

### BACKGROUND

Virtual-machine technology essentially abstracts the hardware resources and interfaces of a computer system on behalf of one or multiple virtual machines, each including one or more application programs and an operating system. Cloud computing services can provide abstract interfaces to enormous collections of geographically dispersed data centers, allowing computational service providers to develop and deploy complex Internet-based services that execute on tens or hundreds of physical servers through abstract cloud-computing interfaces.

Managing and troubleshooting customer data centers which include virtual servers as well as physical servers, virtual machines and virtual applications is often quite difficult. Moreover, any downtime associated with problems in the data center, or components thereof, can have significant impact on a customer relying on the data center.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 is a diagram of the customer support platform's underlying workflow.

FIG. 2 is a diagram of the Word2Vec embedding technique from Google.

FIG. 3 is a diagram of the service component pipelines.

FIG. 4 is a visual comparison of the Bandanau and Luong attention mechanisms.

FIG. 5 is a graph of the training-loss visualization of BERT Model at each training step.

FIG. 6 is a Tensor Board 3D visualization of SR and KB feature vector principal components.

FIG. 7 is a table of masking accuracies from evaluation pipeline report.

FIG. 8 is a recommender system's workflow providing SR, direct and indirect KB recommendations.

FIG. 9 is a table of the top 3 SR and KB recommendations by service.

FIG. 10 is a table of the top 2 KB recommendations by service.

### DETAILED DESCRIPTION OF THE EMBODIMENTS

Proactive customer support is an invaluable advantage for any company aiming to increase customer loyalty. For VMware's enterprise customers, decreasing the number of incidents affecting the IT environments running on our technologies directly impacts customer satisfaction and, by extension, our Net Promoter Score (NPS). As such, the opportunity for improvement in this field is infinite. VMware's customer support platform aims at accomplishing this vision of customer satisfaction by employing an AI-powered, proactive service for knowledge discovery and self-remediation before business-critical applications are impacted.

There is an exceptional opportunity to leverage cross-customer product usage data to provide continuously improved online support, especially for SaaS applications. Additionally, leveraging a global data set to create support rules enables faster product support with reduced mean time of issue resolution. Currently, the customer support service and the customer support platform tend to provide richer and more informed interactions between customers and the company, with capabilities that might transform support operations from reactive to a proactive, predictive, and prescriptive experience without extensive time investments by Technical Support Engineers (TSE). However, ever-growing amount of human-transcribed support requests (SR) and natural lack of domain expertise of TSEs due to the diversity and complexity of customer ecosystems inevitably requires developing appropriate AI-driven approaches. For example, automated identification of similar SRs and respective knowledge article (KB) recommendations with respect to a new issue can greatly enhance the proactive support capabilities and will open new perspectives for self-remediation features within the customer support platform.

The present invention of analytics service in terms of its components for data collection, model training, and knowledge discovery will be described herein. The data pipeline processes a large collection of SRs and VMware KB data and the training pipeline learns VMware-specific language models for insights and recommendations using NLP. We consider a recommender system for customers employing BERT transformer-based language model in more details. It provides proactive capabilities for resolving a customer issue through relevant SR and KB recommendations, rule development guidance, and problem impact estimation.

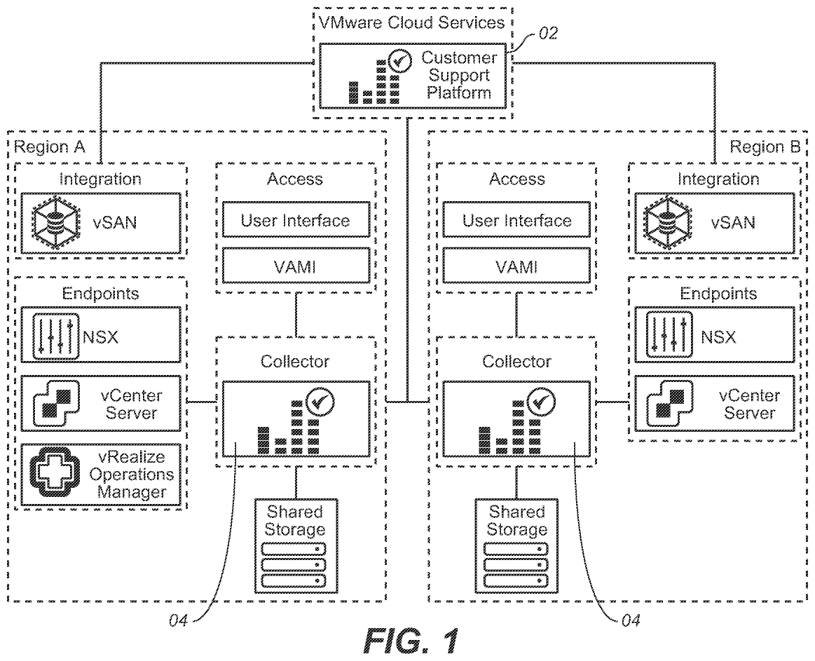

FIG. 1 is a diagram of the customer support platform's 02 underlying workflow. VMware's customer services together with the customer support platform to deliver prompt and proactive support by expanding infrastructure and application visibility with comprehensive analytics based on aggregated product-usage data. The customer support platform solutions prioritize customers behavioral patterns in combination with the infrastructure and applications components. The latest is realized by collector 04 as a virtual appliance to gather and aggregate product-usage information such as configuration, feature, and performance data.

The customer support service and the customer support platform initiate two parallel flows. One of the processes is product monitoring service with generation of specific problem remediation “rules” based on expert knowledge. The second process tries to automate and accelerate a problem resolution by product-data analysis, utilization of best practices, KB articles, SR resolution history, together with application of intelligent machine learning approaches.

Despite the fact that VMware continuously enhances its customer experience and tries to significantly reduce time to resolution by TSE, there is still a huge necessity to develop AI-driven approaches to automatically identify similar problems and corresponding knowledge base resolutions due to intricacy and increasingly high number of support tickets logged each day. One of the most important aspects of this work is to mitigate the complexity of support technologies currently lacking in proactiveness or speed in reactions (time to resolve metrics) which can be substantially improved by leveraging AI methodologies to allow customers prompt remediation options.

Our solution employs a series of varying pipeline services to leverage considerable amount of historical customer-logged SRs and VMware KB articles for training effective language models, which can be leveraged in support analytics and knowledge discovery. We implement and utilize a data pipeline for data scrapping, processing, and analysis, with a training pipeline for organizing, learning, and optimization of our global language models. We then test and evaluate the efficacy of the models using an auxiliary evaluation pipeline mechanism.

The pipeline architecture is one of the significant components of the proposed analytics service targeting prompt data acquisition, efficient model trainings, and fast evaluation of their performance in considerably reduced time investment. As a result, we introduce an intelligent recommender system for the customer support platform customers and the customer support service that enables proactive issue resolution for specific, product-related incidents with the help of relevant SR and KB recommendations. The recommendation system as a service is hosting its own operations and functions by using Bidirectional Encoder Representations from Transformers (BERT) language model and avails itself of several transfer learning practices. In fact, besides opening new perspectives of self-remediation features within the customer support platform, the recommendation system also contributes significantly to the development of support rules and estimation of any problem impact reported.

Unsupervised ML research has shown an extensive effort to discover hidden patterns from customer logged SRs, especially by categorizing and clustering of those into support problem topic groups. Many modern businesses (such as Amazon, HP, IBM, Spotify, etc.) have been using NLP-based recommendation systems to either target their customers, understand and measure user/customer satisfaction, or provide enhanced customer experience by recommending services, coordination and support producing various AI-powered recommendation solutions.

All the solutions available for either research or business purposes employ variety of ML algorithms from natural language processing. The solution services are mainly focused on text classification, pattern discovery, and user-oriented recommendation engines using statistical, probabilistic, and NN-based models to achieve maximum proactive insight discovery and support. On one hand, there are many probabilistic graphical models under Collaborative Topic Regression (CTR) umbrella, such as LDA, hierarchical LDA, model-based collaborative filtering and probabilistic matrix factorization that produce interpretable topic discovery results. On the other hand, the latent representations learned from those models do not often express sufficient effectiveness due of the sparsity in auxiliary information available.

Different NLP-based approaches, such as TF-IDF, Bag-of-Words, Universal Sentence Encoding and many others have proven to adequately detect useful text patterns while working with documents as representation vectors of features or embeddings. These and other more DL models recently show huge potential for learning effective word embedding representations and deliver state-of-the-art performance in NLP applications.

The embedding techniques usually focus on to leverage either context-dependent or context-independent aspects of variety of words in text documents using directional and bidirectional embedding strategies respectively. As a result, the directional models read a text from either left-to-right or vice versa, providing single vector representation for each word, whereas bidirectional models are able to digest a text or a sequence of words all at once, with no specific direction.

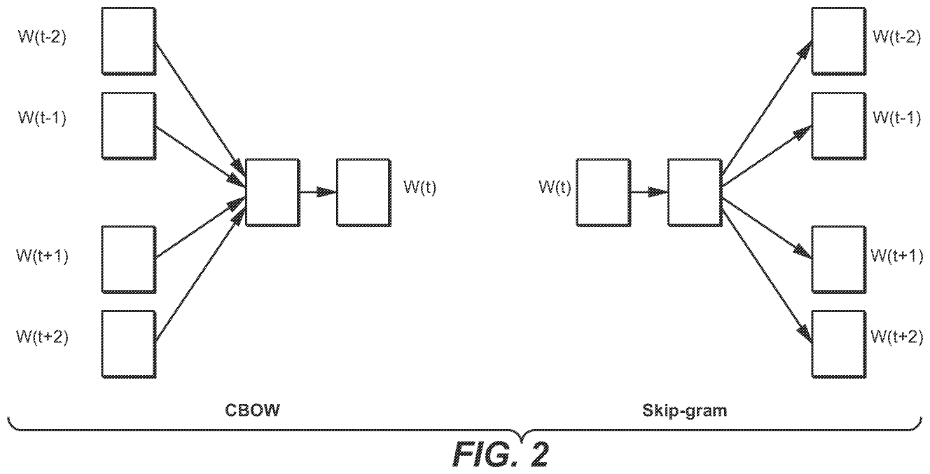

FIG. 2 is a diagram of the Word2Vec embedding technique from Google. Although one of the most significant achievements in NLP field were context independent Word2Vec embeddings, which outperforms classical solutions like TF-IDF in many ways, a research breakthrough introduced Bidirectional Encoder Representations from Transformers (BERT) as another state-of-the-art algorithm in NLP. Due to its bidirectionality, BERT captures the meaning of each word based on context proceeding and following the word and provides context-dependent representation of sentence embeddings with visionary advantage in the field of context learning.

Apparently, all these approaches that evolved into powerful language models (such as Word2Vec, ELMO, GTP-2), employ various strategies/algorithms to compute document feature vectors and capture the semantics of documents by focusing on meanings of documents to build document similarity-based recommendation systems. As a result, several recommendation tools in production utilize techniques from Word2Vec and TF-IDF to represent their text-based features to build useful recommendation engines while employing variety of baseline neighborhood-based algorithms.

The practical applications of the recommendation engines working with text embeddings and similarity measurements build upon not only their capabilities such as good scalability, high accuracy, and flexibility, but also on the quality and granularity levels of the learned representations. Thus, the use of bidirectional context-learners in building similarity-based recommendation engines, exposes significant efficiency to discover more granular knowledge aspects in data and transform those into context-dependent executable representations for efficient recommendations.

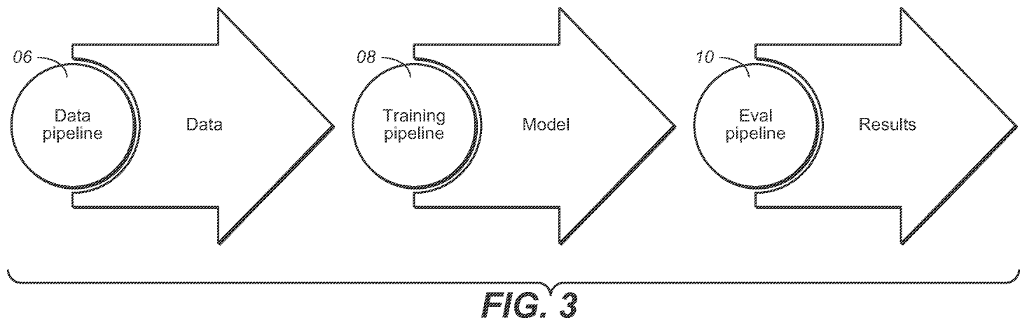

FIG. 3 is a diagram of the service component pipelines as described in the present embodiment. In order to perform various trainings and make comparisons between models, three pipeline mechanisms are implemented: data pipeline 06, training pipeline 08, and evaluation pipeline 10.

The first and one of the most interactive components in our analytics service is the data pipeline 06. The main functionalities of data pipeline 06 include leveraging SR and KB data from different sources such as the customer support service support database management systems, publicly available VMware KB data pool, etc., data filtering and processing, storing and shipping it to organize non-stop language model trainings in the training pipeline 08. The data we are interested in includes combinations of SRs and KBs. The data pipeline 06 utilizes a Salesforce REST Client to query and scrap the customer-filed support incidents using several filtering rules to obtain only SRs which:
are resolved (composing 98% of all cases),
are technical,
are English (filed within the last 2 years),
contain a description consisting of more than 15 ASCII characters
   to construct the training dataset. It also integrates preliminarily implemented data scrapping mechanisms to acquire and store VMware KBs data by filtering out non-English and incomplete KB instances in structure.

Those SRs are almost always unstructured as they represent human-transcribed descriptions of support incidents received and stored from different sources (such as emails, phone calls, etc.). The KBs, in contrast, are usually very well-structured as they are produced by either TSE or the customer support service following the general VMware technical writing guidelines. To improve the quality of text data for language modeling, we enable the data pipeline 06 with several classical data cleaning mechanisms for SRs and KBs such as stop word removal, case normalization, word stemming, lemmatization etc. As a result, the data pipeline 06 delivers clean and structured dataset consisting of 1.2M of SRs and 17.4K of VMware KBs.

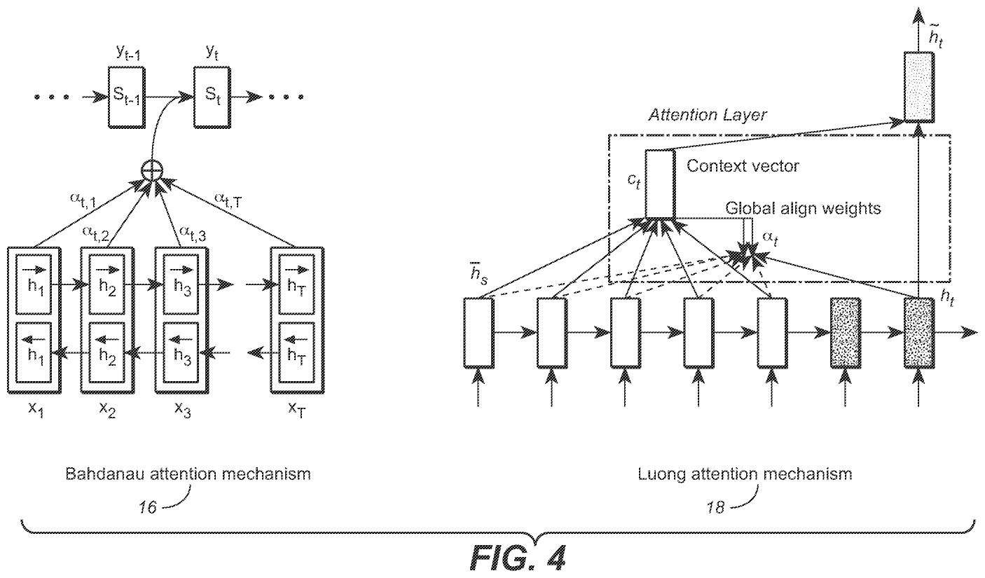

FIG. 4 is a visual comparison of the Bandanau (16) and Luong (18) attention mechanisms. Sequence-to-sequence autoencoder models with attention are used to train encoder-decoder models. Further, the encoder model will serve as a feature extractor module. It takes SR/KB text as an input and gives feature vector as output. Similar SRs/KBs will get similar feature vectors. So, two slightly different approaches are experimented. The difference between them is the attention mechanism.

Bandanau attention 16 (additive attention) uses the concatenation of the forward and backward hidden states in the bi-directional encoder and previous target's hidden states in their non-stacking unidirectional decoder as shown in FIG. 4. Meanwhile, Luong attention 18 (multiplicative attention) uses hidden states at the top LSTM layers in both the encoder and decoder.

Experiments have shown that Bandanau attention 16 slightly outperforms Luong attention 18, which influenced our use of Bandanau attention 16 with 1024 units as the final model. After training the model for about 50 epochs using reconstruction loss, the final encoder and decoder models were split and used separately. While inferencing the model, only encoder module was used in the following way: for each SR and KB feature vectors are extracted and stored. Using these vectors, we can find the most similar ones calculating the cosine similarity between them.

In the present embodiment, BERT is the preferred method. Key technical innovation of BERT is application of the bidirectional training of transformers to language modeling. This is in contrast to previous efforts which looked at a text sequence either from left to right or combined left-to-right and right-to-left training. A language model trained bidirectionally can have a deeper sense of language context and flow than single-direction language models. The novelty of the approach is in the technique named masked language modeling (MLM) which allows bidirectional training in models in which it was previously impossible. BERT is undoubtedly a breakthrough in the use of machine learning for natural language processing. It allows fast fine-tuning which will likely allow a wide range of practical applications.

There are several pretrained BERT models with different architecture sizes. The present embodiment uses the BERT-Large pretrained model (24-layer, 1024-hidden, 16-heads, 340M parameters). BERT has “cased” and “uncased” models. Uncased models are used, as our data does not contain any case sensitive information. It should be appreciated that cased models may also be applied to the current invention.

There are two different techniques for word masking: random selection of masks, and whole word masking. In the last one, all tokens corresponding to a word always are masked at once. Experiments showed that whole word masking technique slightly outperforms. The vocabulary of the BERT model is fixed and contains 30,522 tokens. The first 994 tokens are [unused]. Firstly, all the tokens which appear more than 20 times in our SR+KB dataset are extracted and more than 1500 tokens that are not in BERT's vocabulary (not counting common words and tokens that appear fewer than 20 times) are stored. The top 994 tokens were inserted into BERT's vocabulary. Longer sequences are disproportionately expensive because attention is quadratic to the sequence length. To speed up pretraining in our experiments, we pre-train the model with sequence length of 128 for 90% of the steps. Then, we train the rest 10% of the steps of sequence of 512 to learn the positional embeddings.

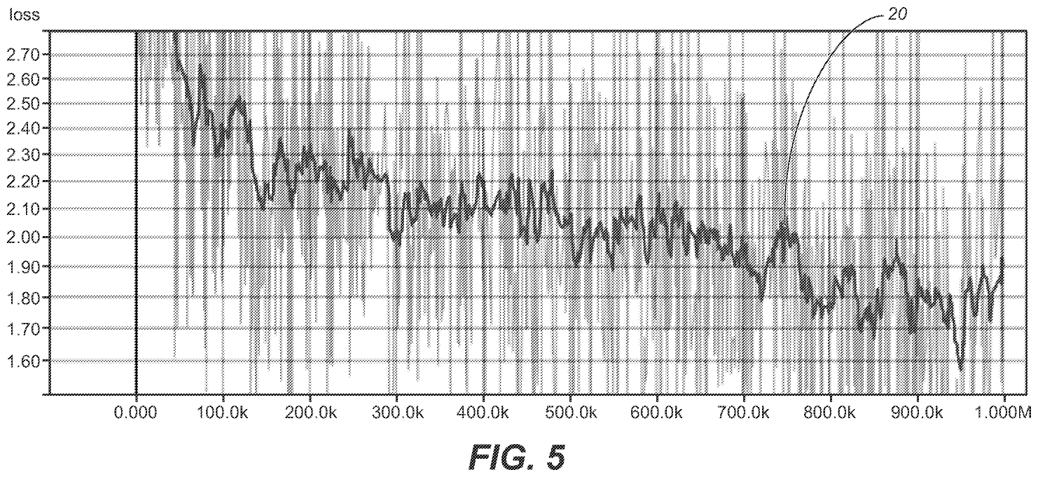

FIG. 5 is a graph of the training-loss visualization of BERT Model at each training step. The main goal of fine-tuning is adjustment of the general BERT model to VMware specific language. FIG. 5 validates our intuition that fine-tuning improves the performance of the model as the corresponding loss function 20 reduces significantly over time.

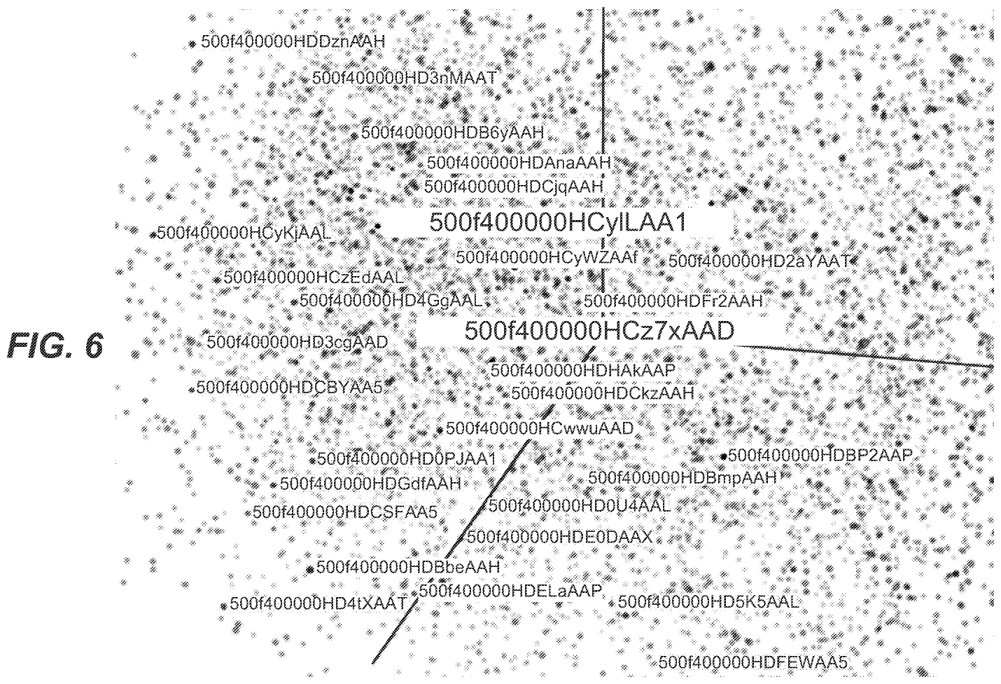

FIG. 6 is a Tensor Board 3D visualization of SR and KB feature vector principal components. After deriving all feature vectors for SRs and KBs, we measure the similarity of feature vectors of those using cosine similarity distance, where similar SRs and KBs should have collinear feature vectors with cosine distance equal to 1, meaning adjacent feature vectors correspond to similar SR documents.

In another embodiment vBERT, which represents a pre-trained model of BERT, may also be used. vBERT is designed to improve the performance of NLP tasks which incorporate VMware-specific language. vBERT model has been fine-tuned using the SR/KB data, that were preprocessed using vNLP preprocessor. Our experiments have shown that the BERT-based models slightly outperform vBERT-based models with respect to masking accuracies, subjective test results and relevancy in the recommended list of SRs and KBs.

In order to make comparison between trained models and understand the best hyperparameter settings and the reliable subset of data for models to be trained on, we derive several evaluation strategies closing the loop for component pipelines using the evaluation pipeline 10. Its extensive effort is to generate reports about the performance of several models in different settings of hyperparameters, provide performance similarities and dissimilarities from benchmarks and derive the most efficient settings of hyperparameters improving masking accuracies.

Although, we have experimented with different NLP methods (such as Autoencoders, vBERT etc.), our primary goal is not to investigate every NLP solution for the task, but rather incorporate the state-of-the-art solution of BERT to design and implement an intelligent recommender system. As a matter of fact, the evaluation pipeline 10 helps to identify the best performing model out of several BERT-based models with corresponding settings of model hyperparameters.

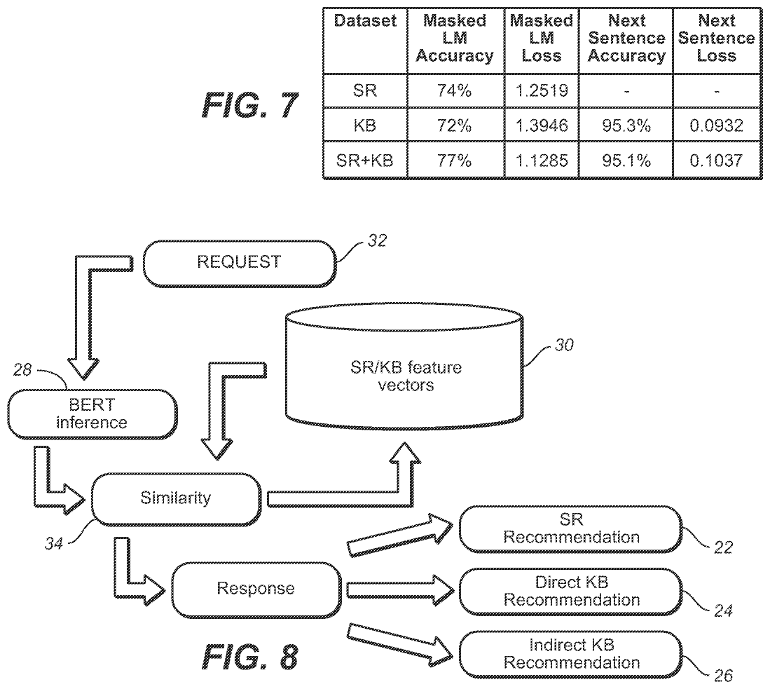

FIG. 7 is a table of masking accuracies from evaluation pipeline 10 report. The subjective tests show that the most recently trained BERT-based model performs adequately well, providing relevant lists of recommendations of SRs and KBs.

FIG. 8 is a recommender system's workflow providing SR 22, direct and indirect KB recommendations (24 and 26). Afterall, we consider a recommender system employing BERT transformer-based language model with all its capabilities. It provides prompt recommendations for SR-to-SR, as well as SR-to-KB (and vice-versa) use cases.

All the SRs and KBs are passed through the fine-tuned BERT-based feature extractor module 28. The resulting parsed feature vectors 30 are stored. Then a REST API-based module 34 is deployed on the server that is responsible for making recommendations of similar SRs and possible helpful KBs for given SR. The API interface consists of the following functionalities: one makes request to the API specifying an SR (by ID or in text format) and similarity threshold value that is responsible for sensitivity of the count of top recommendations. Then, the inner microservices parse the feature vector of the SR using feature extractor module under the hood and find SRs and KBs with similar feature vectors. Besides recommending KBs with similar feature vectors, the API 34 is also enabled to make direct recommendations of KBs for similar SRs, using SR-to-KB linkage dataset. So, once a new recommendation is requested 32, the system passes the requested SR or KB plaintext for BERT inference 28 of feature vectors. Then it measures the cosine similarity between newly inferred feature vector and previously learned and stored feature vectors 30. As a result, our recommender system provides three types of recommendations: list of similar SRs, list of direct and indirect KBs.

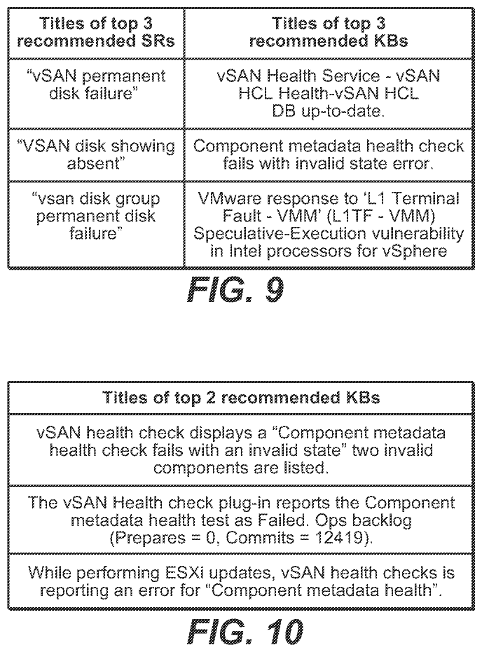

FIG. 9 is a table of the top 3 SR and KB recommendations by service, which shows a particular example of recommender system's output for a sample input support request:
“VSAN Disk showing Permanent disk failure”.

Due to its fast and meaningful recommendations, the engine provides closely similar historical support incidents with corresponding resolutions and KB articles as a relevant knowledge discovery. The functionality of recommender system also extends itself by finding the most similar KB articles whenever a knowledge base symptom or any other component of KB is processed.

FIG. 10 is a table of the top 2 KB recommendations by service. From this it can be observed the most similar KBs recommended for an arbitrary KB symptom:
“The vSAN Health check plug-in reports the Component metadata health test as Failed”.

In fact, an absence of SRs in the output list of recommendations is a good indication of lower resolution coverage for support incidents that could be remediated using this specific KB article. As a result, these lists of recommendations in both examples contain all necessary information to immediately remediate subjective support cases using either directly recommended KBs or those discovered in resolution texts of recommended SRs.'

In one embodiment, the recommender system may act to create its own rules to operate by, based on the system described above. This may be done with the storage and comparison of feature vectors, a trend analysis of the outputted SR and KB recommendations, or other similarly effective methods. In another embodiment, a user may generate their own rules for the system to follow. In another embodiment, VMware or similar admin may track trending issues among users and preemptively push appropriate rules to the user's system. VMware or similar admin may track trending issues using data such as frequency analysis, clustering feature vectors, density, or other relevant data.

In one embodiment, the present invention may retrain the company or technology specific language model through the use of an updated set of user support requests or admin noticed issues. In one embodiment, these requests or issues are stored in the global training database. With the retraining capabilities, the recommender system is capable of continuously improving itself which results in more accurate resolution recommendations.

While all these model-related accuracy metrics defined at the evaluation pipeline 10 are capable of estimating the most appropriate settings of model hyperparameters and help to make relevant conclusions about model selection, there is still a natural necessity to set up external validation mechanisms to test the performance efficiently of recommender system with respect to user feedback. Under this motivation, the recommender system solution has been introduced for expert validation criteria, as several TSEs have already started to validate the system output against historical and newly observed SR and KB samples. At the same time, we consider some other approaches, measuring the direct, indirect and combined accuracies of recommender system outputs, such as estimation of coverage of similar SRs connected to a single KB, feature vector divergence between SR and KBs, and a combination method of these two, estimating the overall quality of recommendations for each and every sample.

We introduced an NLP-based intelligent recommender service using BERT transformer-based language modeling. We designed and employed several pipeline architectures (06, 08, 10) to leverage and process a large collection of VMware support requests and KB articles by training (transfer learning), fine-tuning, and evaluating the performance of several NLP language models feeding the recommender system.

Our research exposes significant efficiency in discovering granular knowledge aspects of SRs and KBs by delivering an automated document similarity-based recommender system that identifies similar support incidents and respective KBs as resolutions, without extensive time investments by TSE. With such an approach we can enable faster product support with reduced mean time of issue resolution. Moreover, our ML-powered recommender system as a service hosting its own operations, can enhance the proactive support capabilities and introduce powerful self-remediation features for the customer support platform 02, targeting advanced and more informed interactions between customers and the company. The deep analytics of the recommender system opens visionary perspectives to develop more relevant support rules, automate their creation, and estimate the impact of any problem in customer environment with substantially reduced time to investigation.

Although, our solutions are generally applicable to the customer support platform as enhancement of its capabilities, there are several interesting challenges that remain in the roadmap, serving as useful directions for future extension of this work. While we have experimented with BERT and its powerful potential to derive visionary advantage in learning VMware specific language, we can further extend its efficiency for more comprehensive knowledge discovery of support incidents using already extracted feature vectors. Moreover, we can identify trending SRs and important KBs with big coverages and use the recommender system to construct new support rules for some empty SR topics. With such abundance of relevant proactive support problems, we expect to achieve maximum oversight incorporating solutions as ML-driven benchmarks.

What we claim is:

1. An AI-driven support system comprising:
A request formed from least one of a support request and a knowledge base;
An extractor module comprising:
A data pipeline configured to construct a training dataset;
A training pipeline configured to take said training dataset and generate at least one feature vector; and
An evaluation pipeline fit to compare outputs from at least one iteration of said training pipeline, as well as output at least one parsed feature vector;
A recommendation module configured to request one of said support request and a corresponding feature vector from said parsed feature vector, and comparing said corresponding feature vector to at least one remaining feature vector to find similar feature vectors, said recommendation module further configured to store said parsed feature vectors to compare with future iterations that generate at least one new parsed feature vector; and
At least one recommendation which is generated based on said similar feature vectors, and trends in said recommendations are tracked and used to create at least one rule.

2. The AI-driven support system of claim 1 wherein, said data pipeline has an input of at least one of said support request and said knowledge base.

3. The AI-driven support system of claim 1 wherein, said training pipeline uses a BERT language model to generate said feature vector.

4. The BERT language model of claim 3 wherein, a random selection masking technique is used.

5. The BERT language model of claim 3 wherein, a whole word masking technique is used.

6. The AI-driven support system of claim 1 wherein, said recommendation module uses a cosine similarity measurement to compare said parsed feature vectors to said new parsed feature vectors.

7. The AI-driven support system of claim 1 wherein, said recommendation is a support request recommendation.

8. The AI-driven support system of claim 1 wherein, said recommendation is an indirect knowledge base recommendation.

9. The AI-driven support system of claim 1 wherein, said recommendation is a direct knowledge base recommendation.

10. The AI-driven support system of claim 1 wherein, a user may create rules for said recommendation module to use.

11. The AI-driven support system of claim 1 wherein, an admin may forward new rules to a user's systems.

12. An AI-driven support system comprising:
A request formed from least one of a support request and a knowledge base;
An extractor module comprising:
A data pipeline configured to construct a training dataset from an input of at least one of said support request and said knowledge base;
A training pipeline configured to take said training dataset use a BERT language model to generate at least one feature vector; and
An evaluation pipeline fit to compare outputs from at least one iteration of said training pipeline, as well as output at least one parsed feature vector;
A recommendation module configured to request one of said support request and a corresponding feature vector from said parsed feature vector, and comparing said corresponding feature vector to at least one remaining feature vector to find similar feature vectors, said recommendation module further configured to store said parsed feature vectors to compare with future iterations that generate at least one new parsed feature vector; and
At least one recommendation which is generated based on said similar feature vectors, and trends in said recommendations are tracked and used to create at least one rule.

13. The BERT language model of claim 12 wherein, a random selection masking technique is used.

14. The BERT language model of claim 12 wherein, a whole word masking technique is used.

15. The AI-driven support system of claim 12 wherein, said recommendation module uses a cosine similarity measurement to compare said parsed feature vectors to said new parsed feature vectors.

16. The AI-driven support system of claim 12 wherein, said recommendation is a support request recommendation.

17. The AI-driven support system of claim 12 wherein, said recommendation is an indirect knowledge base recommendation.

18. The AI-driven support system of claim 12 wherein, said recommendation is a direct knowledge base recommendation.

19. The AI-driven support system of claim 12 wherein, a user may create rules for said recommendation module to use.

20. The AI-driven support system of claim 12 wherein, an admin may forward new rules to a user's systems.
